(19) United States
(12) Patent Application Publication
(10) Pub. No.: US 2025/0307991 A1
(43) Pub. Date: Oct. 2, 2025

(54) INFORMATION PROCESSING APPARATUS

(71) Applicant: TOYOTA JIDOSHA KABUSHIKI KAISHA, Toyota-shi Aichi-ken (JP)

(72) Inventor: Sota Matsuzawa, Nerima-ku Tokyo (JP)

(73) Assignee: TOYOTA JIDOSHA KABUSHIKI KAISHA, Toyota-shi Aichi-ken (JP)

(21) Appl. No.: 19/088,424

(22) Filed: Mar. 24, 2025

(30) Foreign Application Priority Data
Mar. 27, 2024 (JP) 2024-051749

(51) Int. Cl. G06T 5/50; G06V 20/59

(52) U.S. Cl. CPC G06T 5/50; G06V 20/59; G06T 2207/20221

(57) ABSTRACT

An information processing apparatus comprises controller comprising at least one processor configured to perform: obtaining a template for creating combined moving image data in which a plurality of moving image data are combined and, which includes information on at least one extraction condition defined based on a plurality of types of data, extracting a plurality of second moving image data that is moving image data in a predetermined period including a timing that conditions one or more the extraction conditions indicate are satisfied from first moving image data captured by an in-vehicle camera, creating the combined moving image data by combining the second moving image data extracted according to the template.

### CROSS REFERENCE TO THE RELATED APPLICATION

This application claims the benefit of Japanese Patent Application No. 2024-051749, filed on Mar. 27, 2024, which is hereby incorporated by reference herein in its entirety.

### BACKGROUND

### Technical Field

The present disclosure relates to a technique for editing captured moving image data.

### Description of the Related Art

A technique obtaining an image by an in-vehicle camera or performing a predetermined process on the obtained moving image when a vehicle satisfies predetermined condition until the vehicle is running is known.

In this regard, for example, in Patent Literature WO 2013/094405, a device is disclosed that enlarges and indicates the priority monitoring targets included in the moving image captured by the in-vehicle camera of a vehicle based on the position information of the vehicle.

### SUMMARY

An object of the present disclosure is to create a moving image rich in undulations based on a moving image captured by an in-vehicle camera.

One aspect of the present disclosure is as follows:

An information apparatus comprising a controller comprising at least one processor configured to perform; obtaining a template for creating combined moving image data in which a plurality of moving image data is combined, and which includes information on at least one extraction condition defined based on a plurality of types of data, extracting a plurality of second moving image data that is moving image data in a predetermined period including a timing that conditions one or more the extraction conditions indicate are satisfied from first moving image data captured by an in-vehicle camera, and creating the combined moving image data by combining the second moving image data extracted according to the template.

Other aspects include a method executed by the information processing apparatus, a program for causing a computer to execute the method, or a computer-readable storage medium on which the program is stored non-temporarily.

According to the present disclosure, a moving image rich in undulations can be created based on the moving image captured by the in-vehicle camera.

### BRIEF DESCRIPTION OF THE DRAWINGS

FIG. 1 is a diagram indicating an overview of the process executed by the server device according to the first embodiment.

FIG. 2 is a diagram illustrating the components of the server device according to the first embodiment.

FIG. 3 is a diagram illustrating the components of the in-vehicle device according to the first embodiment.

FIG. 4 is a flowchart of a processing executed by the controller server device according to the first embodiment.

FIG. 5 is a diagram illustrating a processing of creating combined moving image data from the first moving image data.

FIG. 6 is a flowchart of a processing executed by the control unit of the server device according to the second embodiment.

### DESCRIPTION OF THE EMBODIMENTS

### (Overview)

A technology is known to create a summary moving image that summarizes the moving image data constantly captured by the in-vehicle camera mounted on the vehicle. For example, the apparatus for creating a summary moving image partially select and combine the moving image data captured at a timing at which the status of the vehicle equipped with an in-vehicle camera satisfies a specific condition to create a summary moving image. However, in this case, if only the images captured at a timing that satisfies a single condition are stitched together, the content of the summary moving image may become monotonous. For example, when a condition is set that the volume of the voice in the car is higher than a predetermined value, only the scene where a predetermined amount of laughter or more laughter occurs or a scene where a predetermined amount or more of a speaking voice is emitted is selected. When only a single condition is set in this way, only the moving image data taken in similar situations is selected, and the moving image data captured under a wide variety of situations that occur during one drive cannot be selected, and a summary moving image rich in undulations cannot be created. In such an apparatus, it is desirable to be able to appropriately select the moving image data captured under a wide variety of situations, rather than selecting only the moving image data captured under a small number of situations.

The present disclosure in its one aspect provides an information processing apparatus comprising a controller comprising at least one processor configured to perform:
obtaining a template for creating combined moving image data in which a plurality of moving image data is combined, and which includes information on at least one extraction condition defined based on a plurality of types of data,
extracting a plurality of second moving image data that is moving image data in a predetermined period including a timing that conditions one or more the extraction conditions indicate are satisfied from first moving image data captured by an in-vehicle camera, and
creating the combined moving image data by combining the second moving image data extracted according to the template.

The first moving image data is the moving image data captured by the in-vehicle camera. The first moving image data is moving image data captured by the in-vehicle camera and may be data that has not been edited or processed, and may be, for example, always captured by the in-vehicle camera.

The extraction condition is information indicating the conditions used when extracting the second moving image data from the moving image captured by the in-vehicle camera. The extraction condition may be expressed as a condition in a situation at the time when capturing images is performed. The extraction condition indicates the state of the vehicle or the condition inside the vehicle at the time when the first moving image data is captured, and the moving image data at the timing at which the extraction condition is satisfied is extracted. The extraction condition is defined based on multiple types of data. For example, the extraction condition may be defined based on two types of data: the data that indicating “being passed a specific point” and “that the situation in the vehicle satisfied a specific condition”.

A template is a frame used to create combined moving image data. The template is set with information on extraction conditions for extracting the moving image data identified as moving image data to be included in the combined moving image data to be created.

The second moving image data is data obtained by extracting specific moving image data from the first moving image data. Specifically, the second moving image data is a moving image data obtained by extracting a predetermined range from the timing at which the conditions indicated by the extraction conditions are satisfied among the first moving image data.

The combined moving image data is data obtained by combining a plurality of second moving image data extracted from the first moving image data to create a single moving image data. The combined moving image data is data obtained by combining a plurality of second moving image data based on the conditions set in the template.

The information processing apparatus according to the present disclosure extracts a plurality of second moving image data captured at a timing at which the conditions indicated by the extraction conditions set in the template are satisfied from the first moving image data constantly captured by the in-vehicle camera. Then, the information processing apparatus according to the present disclosure combines a plurality of second moving image data according to the template to create combined moving image data.

Since the extraction conditions are set in the template, the information processing apparatus according to the present disclosure can extract a moving image from the first moving image data under arbitrary conditions. Thereby, the information processing apparatus according to the present disclosure can edit a moving image captured by the in-vehicle camera to create a moving image rich in undulations.

Further, the present disclosure in its one aspect provides the information apparatus, wherein the conditions indicated by the extraction conditions include at least one of: (1) that the in-vehicle camera has captured a specific object, (2) that sensors included in a vehicle equipped with the in-vehicle camera has detected predetermined data, (3) that the vehicle has passed through a specific point, or (4) that a position of a shift lever equipped by the vehicle is in a predetermined position.

Thereby, the information processing apparatus according to the present disclosure can select appropriate moving image data according to the driving status of the vehicle or the situation inside the vehicle.

Further, the present disclosure in its one aspect provides the information apparatus, wherein the controller may receive the first moving image data and the data detected by the sensors included in the vehicle from the vehicle equipped with the in-vehicle camera, and determines a timing at which the conditions indicated by the extraction conditions are satisfied based on the data, in creation of the combined moving image data.

Thereby, the information processing apparatus according to the present disclosure can create a summary moving image for each vehicle by receiving the first moving image data and the data detected by the sensor equipped by the vehicle from a plurality of vehicles. For example, the information processing apparatus according to the present disclosure may be a server device that receives first moving image data or the like from a vehicle and create summary moving image.

Further, the present disclosure in its one aspect provides the information apparatus, when the conditions indicated by the extraction conditions are satisfied, wherein the controller may extract the first moving image data captured by the in-vehicle camera at a corresponding timing and may use the extracted moving image as the second moving image data.

Thereby, the information processing apparatus according to the present disclosure can extract appropriate moving image data from the first moving image data captured by the in-vehicle camera in real time when the conditions indicated by the extraction conditions are satisfied. Therefore, the information processing apparatus according to the present disclosure can create a summary moving image from the first moving image data in the vehicle without communicating with the external device while the vehicle is running.

Further, the present disclosure in its one aspect provides the information apparatus, wherein the controller may obtain a plurality of templates in which information of different contents related to the extraction conditions is set respectively and select one of the plurality of templates in creation of the combined moving image data.

Thereby, the information processing apparatus according to the present disclosure can create moving images based on various types of templates with the different extraction conditions. Therefore, the information processing apparatus according to the present disclosure can create a moving image having appropriate contents according to the needs of the user.

Specific embodiments of the present disclosure will be described below on the basis of the drawings. The hardware configuration, module configuration, functional configuration, and the like described in each embodiment are not intended to limit the technical scope of disclosure to only them unless otherwise stated.

### First Embodiment

### <Overview of Processing Executed by the Server Device>

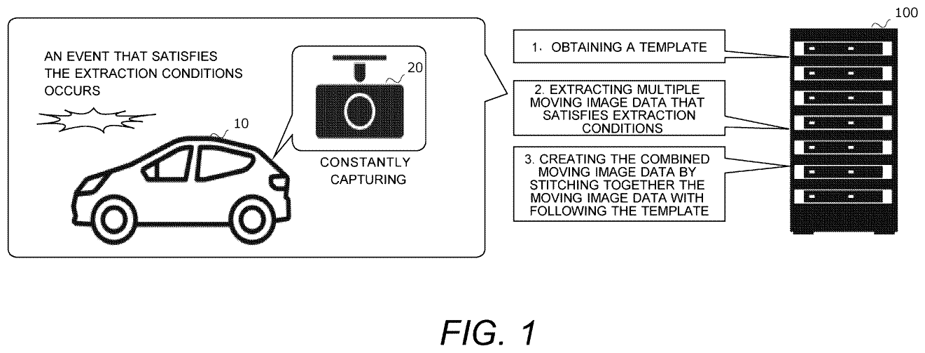

An overview of the processing performed by the information processing apparatus according to the embodiment will be described with reference to FIG. 1. FIG. 1 indicates an overview of the processing executed by the information processing apparatus related to the embodiment. The information processing apparatus according to the embodiment is realized, for example, as the server device 100. Here, the server device 100 may be, for example, a device mounted on the vehicle 10 comprising a processor and a memory, or a device installed outside the vehicle 10 and capable of communicating with the vehicle 10. The server device 100 receives the moving image data captured by the in-vehicle camera 20 comprised in the vehicle 10, creates summary moving image summarizing the moving image data captured while the vehicle is running by extracting appropriate portions from the moving image data and combining them. In the first embodiment, a form in which the server device 100 is installed outside the vehicle 10 will be described, but the server device 100 may be installed in the vehicle.

First, the server device 100 obtains a template for creating combined moving image data, which is a moving image that is a moving image summarizing the moving images captured during the driving of the vehicle 10. In the template, multiple extraction conditions are set, which are conditions for selecting moving images to be incorporated into the combined moving image data. The extraction condition indicates, for example, a condition when a moving image to be incorporated into the combined moving image data is captured. The extraction condition may be defined by a plurality of conditions. The condition for defining the extraction condition is, for example, that the sensor comprised by the vehicle 10 detects predetermined data (for example, when a smile is recognized by an image sensor, or when the loudness of the voice is detected by a sound sensor and the excitement of the conversation is detected). Alternatively, the condition that defines the extraction condition may be, for example, that the vehicle 10 has passed through a specific point such as a toll booth, tunnel, or bridge, or that the image sensor detects a specific landmark.

Next, the server device 100 extracts a plurality of moving image data captured when the conditions indicated by the extraction conditions are satisfied from the moving image data constantly captured by the in-vehicle camera 20. For example, when the extraction condition is that the sensor comprised by the vehicle 10 detects a predetermined data, the server device 100 extracts a plurality of captured moving image data captured at a timing that satisfies the condition.

Subsequently, the server device 100 creates combined moving image data by connecting the plurality of moving image data extracted according to the obtained template. That is, the server device 100 connects the captured moving image data at a timing at which the predetermined conditions indicated by the extraction conditions are satisfied. By stitching together moving image data corresponding to multiple preset extraction conditions, it is possible to select and connect scenes that serve as highlights during the drive and, in doing so, combine them into a single moving image data.

Thus, in the present embodiment, the server device 100 can select an appropriate scene from the driving scene from the moving image data constantly captured by the in-vehicle camera and create a moving image rich in undulations.

### <Configuration of the Server Device>

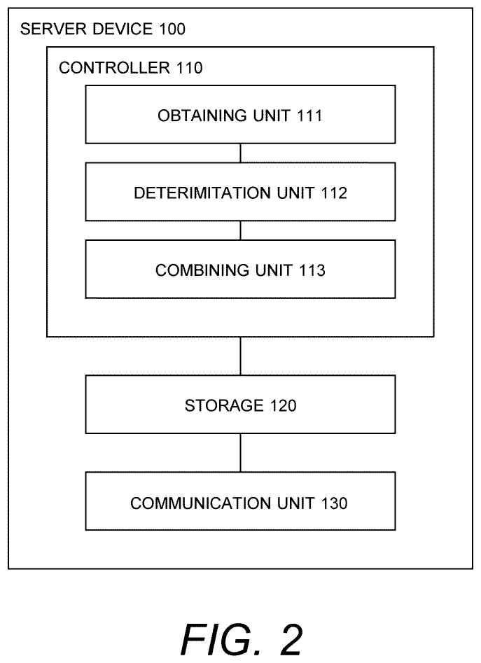

FIG. 2 is a diagram explaining the components of the server device 100 according to the embodiment.

The server device 100 according to the present embodiment comprises a controller 110, a storage 120, and a communication unit 130. The server device 100 receives the moving image data captured by the in-vehicle camera 20 comprised by the vehicle 10 and creates a moving image data that summarizes the moving image data captured while the vehicle 10 is running. The server device 100 may be, for example, an information terminal mounted on the vehicle 10, or a dedicated server device existing outside the vehicle 10 that can communicate with the vehicle 10. In the first embodiment, the server device 100 is installed outside the vehicle 10.

The controller 110 is realized by a processor such as a CPU (Central Processing Unit) or a GPU (Graphics Processing Unit) and a memory. The controller 110 comprises an obtaining unit 111, a determination unit 112, and a combining unit 113 as a functional module. These functional modules may be realized by executing a program by the controller 110.

The obtaining unit 111 obtains the first moving image data, which is the moving image data captured by the in-vehicle camera 20. The obtaining unit 111 may obtain the first moving image data by communicating with the in-vehicle device included in the vehicle 10 via the communication unit 130.

Further, the obtaining unit 111 receives one or more templates from an external device or the like. The template is information indicating a frame for creating combined moving image data in which a plurality of extraction conditions is set, which are conditions for selecting moving images to be incorporated into the combined moving image data.

Further, the obtaining unit 111 may obtain various data obtained from the vehicle 10 via a sensor mounted on the vehicle 10. For example, the various data are data representing sensor data obtained by sensing the driving status of the vehicle or the situation inside the vehicle in a time series (hereinafter referred to as vehicle data). Note that the vehicle data does not have to include the sensor data itself. For example, the vehicle data may be a time-series representation of the result of detecting an event to be detected based on the sensor data. The obtaining unit 111 may obtain the vehicle data by communicating with the in-vehicle device included in the vehicle 10 via the communication unit 130.

Based on the vehicle data, the determination unit 112 determines the timing at which the conditions indicated by the extraction conditions are satisfied in the first moving image data. Specifically, the determination unit 112 determines the timing at which the conditions indicated by the extraction conditions are satisfied in the first moving image data based on the vehicle data and may specify the moving image data for a predetermined period including the timing as a target for extracting.

The combining unit 113 combines the specified second moving image data according to the template to create one combined moving image data. That is, the combining unit 113 combines moving image data that satisfies the predetermined conditions indicated by the extraction conditions among the moving image data captured while the vehicle 10 is running and creates a combined moving image data.

The storage 120 is a main memory such as RAM or ROM, an EPROM, a hard disk drive, and an auxiliary storage device such as removable media. The auxiliary storage device stores an operating system (OS), various programs, various tables, and the like, and by executing the programs stored therein, each function corresponding to a predetermined purpose of each part of the controller 110 can be realized. However, some or all of the functions may be realized by hardware circuits such as ASICs and FPGAs.

The storage 120 stores data used or generated in the processing performed by the controller 110. Further, the storage 120 may store the obtained template, the first moving image data, or various data detected by the sensor comprised by the vehicle 10.

The communication unit 130 includes a communication circuit that performs wireless communication. The communication unit 130 may be, for example, a communication circuit that performs wireless communication using 4G (4th Generation), or a communication circuit that performs wireless communication using 5G (5th Generation). Further, the communication unit 130 may be a communication circuit that performs wireless communication using LTE (Long Term Evolution) or a communication circuit that performs communication using LPWA (Low Power Wide Area). Further, the communication unit 130 may be a communication circuit that performs wireless communication using Wi-Fi (registered trademark).

The vehicle 10 is a vehicle comprising an in-vehicle device 200 and an in-vehicle camera 20. The vehicle 10 is typically a passenger car, a truck, a bus, or the like. The vehicle 10 may be able to communicate with the server device 100 or may be equipped with the server device 100.

### <Composition of In-Vehicle Device>

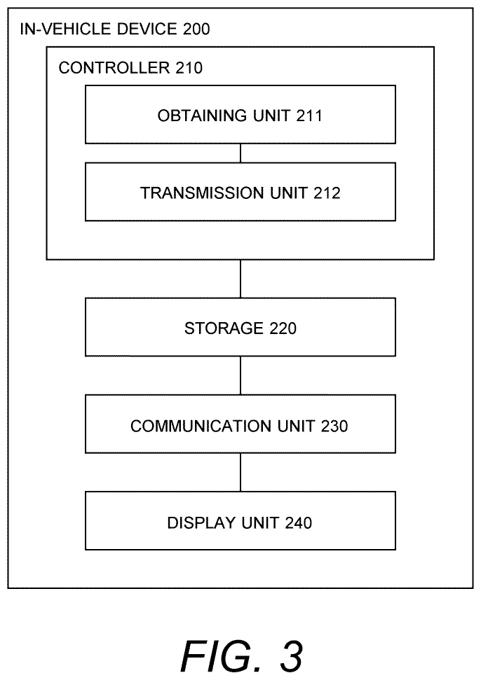

Next, the in-vehicle device 200 will be described. FIG. 3 is a diagram illustrating the components of the in-vehicle device 200. The in-vehicle device 200 is mounted on the vehicle 10 equipped with the in-vehicle camera 20 and communicates with the server device 100. For example, the in-vehicle device 200 may obtain the moving image data captured by the in-vehicle camera 20 from the in-vehicle camera 20 and provide the moving image data to the server device 100.

The in-vehicle device 200 includes a controller 210, a storage 220, a communication unit 230, and a display unit 240. The controller 210, the storage 220, and the communication unit 230 are the same as the controller 110, the storage 120, and the communication unit 130 of the server device 100. The controller 210 comprises an obtaining unit 211 and a transmission unit 212 as a functional module. These functional modules may be realized by executing a program by the controller 210. The components similar to those of the server device 100 will not be described.

The obtaining unit 211 obtains the first moving image data captured by the in-vehicle camera 20 from the in-vehicle camera 20. Further, the obtaining unit 211 may obtain sensor data from various sensors comprised in the vehicle 10 via the ECU and generate vehicle data based on the sensor data. Note that the obtaining unit 211 may store the first moving image data in the storage 220.

The transmission unit 212 transmits the first moving image data obtained by the obtaining unit 211 to the server device 100. Further, the transmission unit 212 may transmit the vehicle data obtained by the obtaining unit 211 to the server device 100.

The display unit 240 is a display that displays an image or the like for providing information to the user. The display unit 240 may be a liquid crystal display or an organic EL (Electro-Luminescence) display. Further, the display unit 240 may be realized as a touch panel display. The display unit 240 may display the combined moving image data created by the controller 210.

### <Operation of the Server Device>

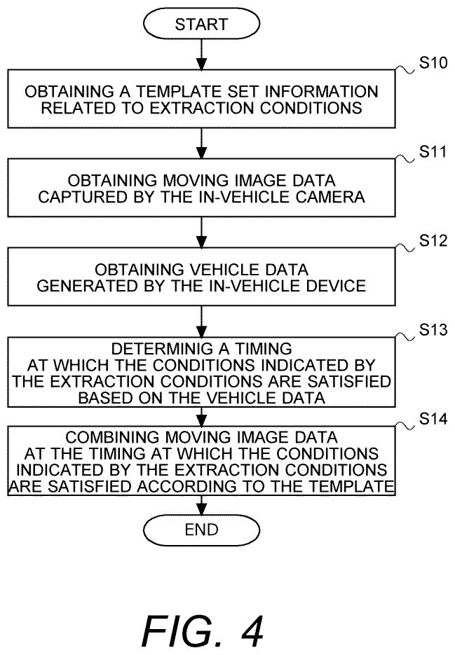

Next, the specific contents of the processing executed by the server device 100 will be described. FIG. 4 is a flowchart of a processing executed by the controller 110 of the server device 100 according to the first embodiment.

The server device 100 starts the processing described in FIG. 3 when it is determined that the main switch of the vehicle 10 has been turned on for a certain period of time and the main switch is turned off, that is, when it can be determined that the vehicle 10 has returned to the warehouse after traveling for a certain period of time. Alternatively, the server device 100 may start the processing described in FIG. 3 when it receives some request from the user of the vehicle 10.

First, in step S10, the obtaining unit 111 obtains a template in which extraction conditions are set from an external device or the like. Here, the extraction condition is information indicating the situation inside the vehicle 10, the state related to the running of the vehicle 10, and the like when the in-vehicle camera 20 is performing imaging, and indicating the condition the moving image data inserted into the combined moving image data should satisfy. When there is a plurality of in-vehicle cameras in one vehicle 10, the extraction condition may include information for specifying an in-vehicle camera that captures a moving image data. For example, the plurality of in-vehicle cameras includes a front camera and a camera mounted in the room of the car.

The extraction conditions include, for example, that the in-vehicle camera 20 captures a specific object, that the sensor comprised in the vehicle 10 detects predetermined data, that the vehicle 10 has passed a specific point, or that the position of the shift lever comprised by the vehicle 10 is in a predetermined position. The conditions specified in the extraction conditions are conditions that are judged in a complex manner based on a plurality of data. For example, the condition indicated by the extraction condition may be a condition determined based on the recognition result of the image obtained by the in-vehicle camera 20, the result of sensing the inside of the vehicle 10 by various sensors, and any or all the driving data of the vehicle 10.

Note that one or more extraction conditions are set in the template. The template may further set the length of the moving image data inserted into the combined moving image data. Note that the obtaining unit 111 may obtain a plurality of templates. For example, the obtaining unit 111 may select one to be used from a plurality of templates based on the user's specification.

Subsequently, in step S11, the obtaining unit 111 obtains the first moving image data that is the moving image data captured by the in-vehicle camera 20. The first moving image data may be moving image data constantly captured by the in-vehicle camera 20. The obtaining unit 111 obtains the first moving image data captured by the in-vehicle camera 20 via the in-vehicle device 200.

Next, in step S12, the obtaining unit 111 obtains vehicle data generated by the in-vehicle device 200 from the vehicle 10. The vehicle data may be time-series data in which the result of detecting the event of the sensor's target and the time at which the event is detected are linked. For example, the sensor mounted on the vehicle 10 is an image sensor, a sound sensor, a weight sensor, and the like. The in-vehicle device 200 may detect the smile of the occupant based on the image data inside the vehicle captured by the in-vehicle camera 20. Further, the in-vehicle device 200 may detect the volume level of the sound in the vehicle, such as the volume of conversation between occupants, based on the output of the sound sensor. The vehicle data may describe these detection results in a time series.

Subsequently, in step S13, the determination unit 112 determines the timing at which the conditions indicated by the extraction conditions are satisfied based on the vehicle data obtained by the obtaining unit 111. For example, when the condition “when the occupant smiles” is set as one of the conditions constituting the extraction conditions, the determination unit 112 may determine the time when a smile is detected based on the vehicle data. The determination unit 112 extracts the moving image data captured at the above timing from the first moving image data as the second moving image data. A plurality of second moving image data may be extracted.

Then, in step S14, the combining unit 113 combines the moving image data at a timing at which the conditions indicated by the extraction conditions are satisfied according to the template. The combining unit 113 combines a plurality of second moving image data according to a template to create combined moving image data. The combining unit 113 may adjust the length of the second moving image data or the like based on the length of a predetermined moving image set in the template inserted or added to the combined moving image data, and a plurality of second moving image data may be combined. Note that the combining unit 113 may select one of the plurality of templates obtained by the obtaining unit 111 and use it for processing this step.

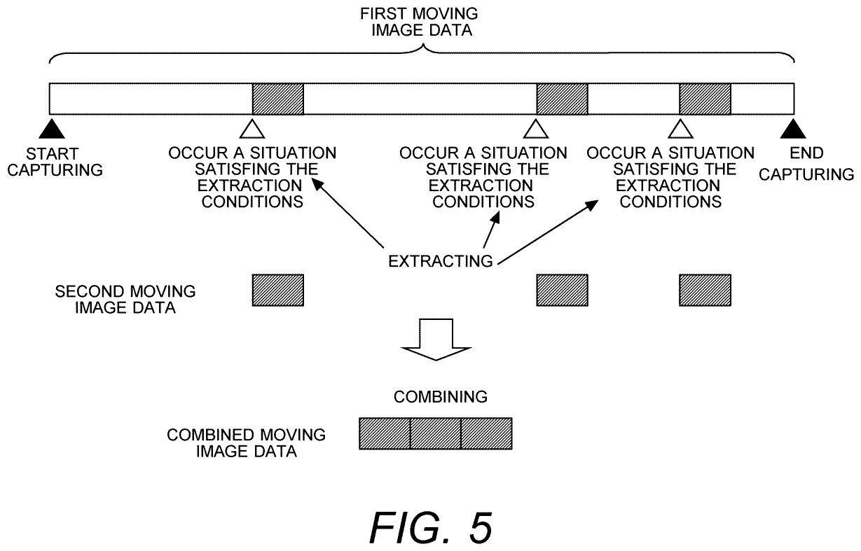

FIG. 5 is a diagram illustrating a processing of creating combined moving image data from the first moving image data. As indicated in FIG. 5, the determination unit 112 extracts a moving image of a predetermined length including a moving image captured at the timing at which the situation indicated by the extraction condition occurs from the first moving image data as the second moving image data. Then, the extracted second moving image data is combined to form the combined moving image data.

Thereby, the server device 100 can select the moving image data captured under a plurality of types of conditions set as extraction conditions in the template from the moving image data captured during the running of the vehicle 10 and summarize it as one moving image data. Therefore, the server device 100 can create undulating moving image data that summarizes the moving image data during the running of the vehicle 10.

### Second Embodiment

In the first embodiment, the server device 100 installed at a place separated from the vehicle 10 collectively obtains the moving image data captured by the in-vehicle camera 20 and the data detected by the sensor included in the vehicle 10 at the time when the vehicle 10 is completed. Then, based on the data, the server device 100 subsequently specified the timing at which the condition indicated by the extraction condition was satisfied, extracted the moving image data of the timing from the first moving image data, and combined them.

However, the server device 100 may be installed in the interior of the vehicle 10 rather than at a place separated from the vehicle 10. In that case, the server device 100 can obtain the moving image data captured by the in-vehicle camera 20 while the vehicle 10 is running, and the server device 100 can obtain the moving image data from the vehicle 10 at any time when the conditions indicated by the extraction conditions are satisfied. The second embodiment is an embodiment in which the server device 100 is installed in the vehicle 10. The server device 100 in the second embodiment obtains the moving image data captured by the in-vehicle camera 20 at each timing at which it is determined that the extraction conditions are satisfied based on various data constantly obtained from the vehicle 10 and combines the obtained moving image data.

### <Processing of the Server Device in the Second Embodiment>

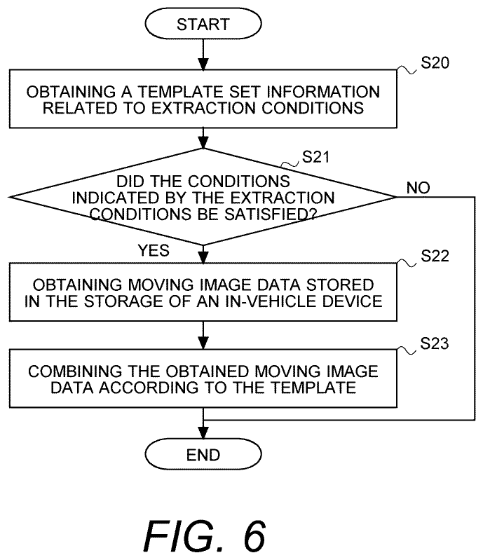

Hereinafter, the processing executed by the server device in the second embodiment will be described in detail. FIG. 6 is a flowchart of a processing executed by the controller server device according to the second embodiment. The server device 100 starts the processing of step S20 when the main switch of the vehicle 10 is turned on or the power of the in-vehicle camera 20 is turned on. Alternatively, the server device 100 may start the processing of step S20 when it receives some input from the user. The processing described in FIG. 6 is executed instead of the processing described in FIG. 4

First, in step S20, the obtaining unit 111 obtains a template in which extraction conditions are set from an external device or the like. The processing step is the same as that of step S10 described in FIG. 3.

Next, in step S21, the determination unit 112 determines whether the conditions indicated by the extraction conditions are satisfied. The determination unit 112 may perform the above determination based on, for example, vehicle data constantly obtained from the in-vehicle device 200. The determination unit 112 determines whether at least one of the extraction conditions set in the obtained template at the current point, that is, the running state of the vehicle 10 or the state of the interior of the vehicle 10, etc., has been satisfied. When the determination unit 112 determines that the conditions indicated by the extraction conditions are satisfied, this step becomes a positive determination.

If a positive determination is obtained in this step, the processing transitions to step S22.

If a negative determination is made in this step, the processing is terminated.

Next, in step S22, the obtaining unit 111 obtains a portion of the first moving image data captured by the in-vehicle camera 20 from the in-vehicle device 200. The obtaining unit 111 may obtain the moving image data captured by the in-vehicle camera 20 for a predetermined period. Alternatively, the obtaining unit 111 may obtain moving image data corresponding to the period during which the conditions indicated by the extraction conditions are satisfied among the first moving image data captured by the in-vehicle camera 20 and stored in the storage 220 of the in-vehicle device 200. In this case, the determination unit 112 may extract the moving image data included in the first moving image data until the end of a predetermined period from the timing at which the extraction condition is satisfied, or during the period when the extraction condition is satisfied. The obtaining unit 111 takes the moving image data obtained in this step as the second moving image data.

In step S23, the combining unit 113 combines the moving image data at a timing at which the conditions indicated by the extraction conditions are satisfied according to the template. The combining unit 113 combines a plurality of second moving image data according to the template to create the combined moving image data. The processing of this step is the same as the processing described in step S14 of FIG. 3.

Thereby, the server device 100 can select the moving image data captured under a plurality of types of conditions set as extraction conditions in the template in real time from the moving image data captured while the vehicle 10 is running and summarize it as one moving image data. Therefore, the server device 100 can immediately create undulating moving image data that summarizes the moving image data during the running of the vehicle 10.

### (Other Modifications)

The above embodiment is only an example, and the present disclosure may be appropriately changed and implemented within a range that does not deviate from the gist.

The present disclosure can also be realized by supplying a computer program implementing the functions described in the above embodiment to a computer and having one or more processors of the computer read and execute the program. Such a computer program may be provided to the computer by a non-transitory computer-readable storage medium that can be connected to the computer's system bus, or it may be provided to the computer over a network. Non-transitory computer-readable storage media include, for example, any type of disk such as a magnetic disk (floppy (registered trademark) disk, hard disk drive (HDD), etc.), optical disc (CD-ROM, DVD disc, Blu-ray disc, etc.), read-only memory (ROM), random access memory (RAM), EPROM, EEPROM, magnetic card, Flash memory, optical cards, including any type of medium suitable for storing electronic instructions.

What is claimed is:

1. An information processing apparatus comprising a controller comprising at least one processor configured to perform:
obtaining a template for creating combined moving image data in which a plurality of moving image data is combined, and which includes information on at least one extraction condition defined based on a plurality of types of data,
extracting a plurality of second moving image data that is moving image data in a predetermined period including a timing that conditions one or more the extraction conditions indicate are satisfied from first moving image data captured by an in-vehicle camera, and
creating the combined moving image data by combining the second moving image data extracted according to the template.

2. The information processing apparatus according to claim 1, wherein the conditions indicated by the extraction conditions include at least one of: (1) that the in-vehicle camera has captured a specific object, (2) that sensors included in a vehicle equipped with the in-vehicle camera has detected predetermined data, (3) that the vehicle has passed through a specific point, or (4) that a position of a shift lever equipped by the vehicle is in a predetermined position.

3. The information processing apparatus according to claim 1, wherein the controller receives the first moving image data and data detected by sensors included in the vehicle from the vehicle equipped with the in-vehicle camera, and
determines a timing at which the conditions indicated by the extraction conditions are satisfied, based on the data, in creation of the combined moving image data.

4. The information processing apparatus according to claim 1, wherein when the conditions indicated by the extraction conditions are satisfied, the controller extracts the first moving image data captured by the in-vehicle camera at a corresponding timing, and uses the extracted moving image as the second moving image data.

5. The information processing apparatus according to claim 1, wherein the controller obtains plurality of templates in which information of different contents related to the extraction conditions is set respectively, and select one of the plurality of templates in creation of the combined moving image data.
